(19) United States
(12) Patent Application Publication
(10) Pub. No.: US 2017/0058488 A1
(43) Pub. Date: Mar. 2, 2017

(54) IMPLEMENT SYSTEM CONTROL DEVICE

(71) Applicant: CATERPILLAR INC., Peoria, IL (US)

(72) Inventor: Christopher R. Wright, Peoria, IL (US)

(73) Assignee: CATERPILLAR INC., Peoria, IL (US)

(21) Appl. No.: 14/838,475

(22) Filed: Aug. 28, 2015

(51) Int. Cl. E02F 9/20; E02F 9/22; G05G 1/04; E02F 3/32

(52) U.S. Cl. CPC E02F 9/2004; E02F 3/32; E02F 9/2267; E02F 9/2271; G05G 1/04

(57) ABSTRACT

A control device for an implement system of a machine is mounted on a base. The control device includes a handle portion having a rotatable sleeve and a control rod encased in the handle portion. A seat is fixed to the control rod at a proximal end of the handle portion. Two linear actuators connected between the base and the seat form a kinematic chain including the linear actuators and the control rod.

### TECHNICAL FIELD

The present disclosure relates generally to a control device for an implement system of a machine, and in particular, to a control device for the implement system of an excavator.

### BACKGROUND

An implement system of a typical excavator machine includes a linkage structure operated on by hydraulic actuators to move a work implement. The implement system includes a boom that is pivotal relative to a machine chassis, a stick that is pivotal relative to the boom, and a work implement that is pivotal relative to the stick. Further, the machine chassis is rotatably mounted on an undercarriage or drive system of the excavator and adapted to swing about a vertical axis.

As known in the art, excavators utilize a right-hand control lever and a left-hand control lever to control movement of the machine chassis, the boom, the stick and the work implement. The control levers are provided in an operator cab and disposed on left and right sides of the operator's seat, respectively. The right-hand control lever controls the movement of the boom and the work implement. The left-hand control lever controls the movement of the stick and the machine chassis. Collectively or individually, the left and right control levers control the movement of the implement system while performing a digging or loading operation. However, this control system requires an operator to learn how to move the work implement by manipulating a rate of change and angular position of the boom, the stick, and the work implement.

U.S. Pat. No. 5,995,893 to Lee, et al. discloses a device for controlling the operation of power excavators including a control lever which is handled simply by one hand. The control lever consists of a plurality of links which are joined together in such a way that the intuitive handling directions of the links are identified with the actual moving directions of the actuators. The links can be selectively rotated, retracted or extended by an operator of the excavator in order to control the motions of the hydraulic actuators. Further, at least two of the links are joined by a linear joint.

### SUMMARY

In one aspect, the present disclosure is directed to a control device for an implement system of an excavator. The control device includes a handle portion having a rotatable sleeve, and a control rod encased in the handle portion. A seat is fixed to the control rod at a proximal end of the handle portion. Two linear actuators are connected between the base and the seat, forming a kinematic chain including the linear actuators and the control rod.

In another aspect of the present disclosure, a machine, such as an excavating machine, is disclosed. The machine includes a drive system, a chassis rotatably supported on the drive system, an implement system connected with the chassis, and a hydraulic control system. The machine further includes a control device for the implement system. The control device is mounted on a base and includes a handle portion having a rotatable sleeve, a control rod encased in the handle portion, a seat fixed to the control rod at a proximal end of the handle portion and two linear actuators disposed in a vertical plane and connected between the base and the seat form a kinematic chain including the linear actuators and the control rod. The control device further includes two collapsible cylinders disposed in an orthogonal plane relative to the vertical plane of the linear actuators and connected between the base and the seat, and an input device disposed on the handle portion. A controller in the machine is configured to control the operation of the hydraulic control system to achieve a scaled up movement of the implement system in response to at least one of a movement of the handle portion with respect to the base and a turning of the input device.

### BRIEF DESCRIPTION OF THE DRAWINGS

FIG. 1 illustrates a diagrammatic view of a machine having an implement system;

FIG. 2 illustrates a side elevation view of an operation interface device of the machine of FIG. 1;

FIG. 3 illustrates a front-side view of the operation interface device of the machine of FIG. 1;

FIG. 4 is block diagram of a control system for the machine of FIG. 1; and

FIG. 5 is a diagrammatic view of the machine and the control device illustrating a movement interrelationship.

### DETAILED DESCRIPTION

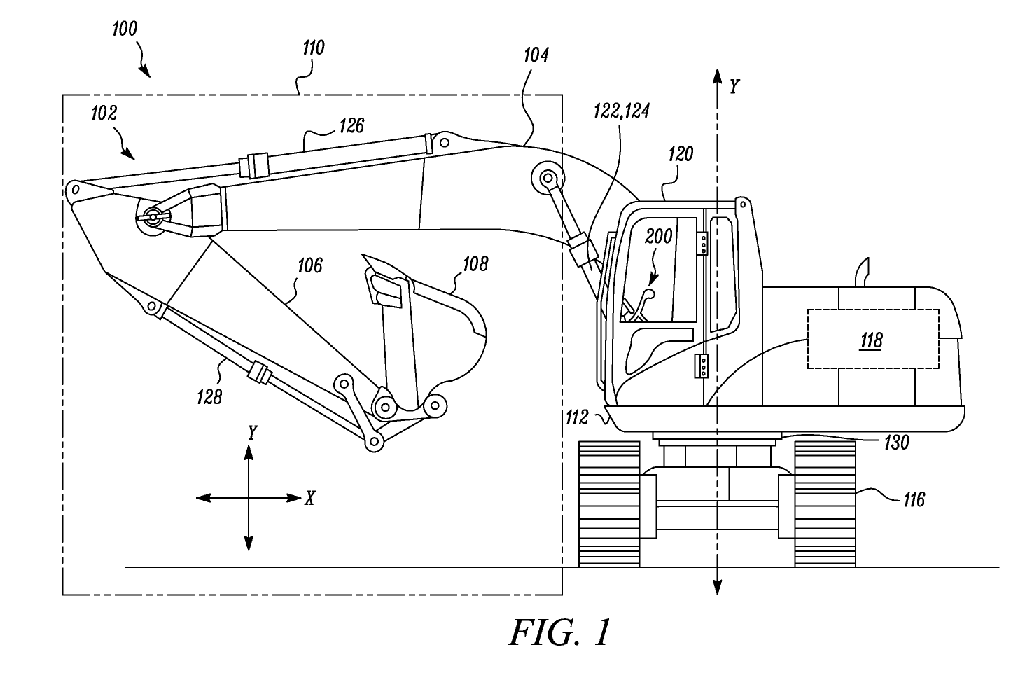

FIG. 1 illustrates a diagrammatic view of a machine 100 having an implement system 102, and a control device 200 for the implement system 102. In the illustrated embodiment, the machine 100 is shown as an excavator-type earthmoving or logging machine and the implement system 102 consists of linkages such as a boom 104, a stick 106, and a bucket 108. The boom 104 is pivotally connected to a chassis 112 of the machine 100, the stick 106 is pivotally connected to the boom 104, and the bucket 108 is pivotally connected to the stick 106. In various other embodiments, the implement system 102 may be an implement system of any other excavator-type of machines, such as backhoe loaders, front shovels, wheel loaders, track loaders, and skidders. Further, as the implement system 102 configuration may differ from one machine to another machine, and the work implement may be other than the bucket 108 which may include, such as, for example a grapple, forks, hammer, rippers, shears, etc.

The machine 100 may also include a drive system 116, such as, for example tracks, for propelling the machine 100, a power source 118 to power the implement system 102 and the drive system 116, and an operator cab 120. The power source 118 may embody an engine, such as, for example, a diesel engine, a gasoline engine, a gaseous fuel-powered engine or any other type of combustion engine known in the art. It is contemplated that the power source 118 may alternatively embody a non-combustion source of power such as a fuel cell, a power storage device, or another source known in the art. The power source 118 may produce a mechanical or electrical power output that may then be converted to hydraulic power for moving the implement system 102.

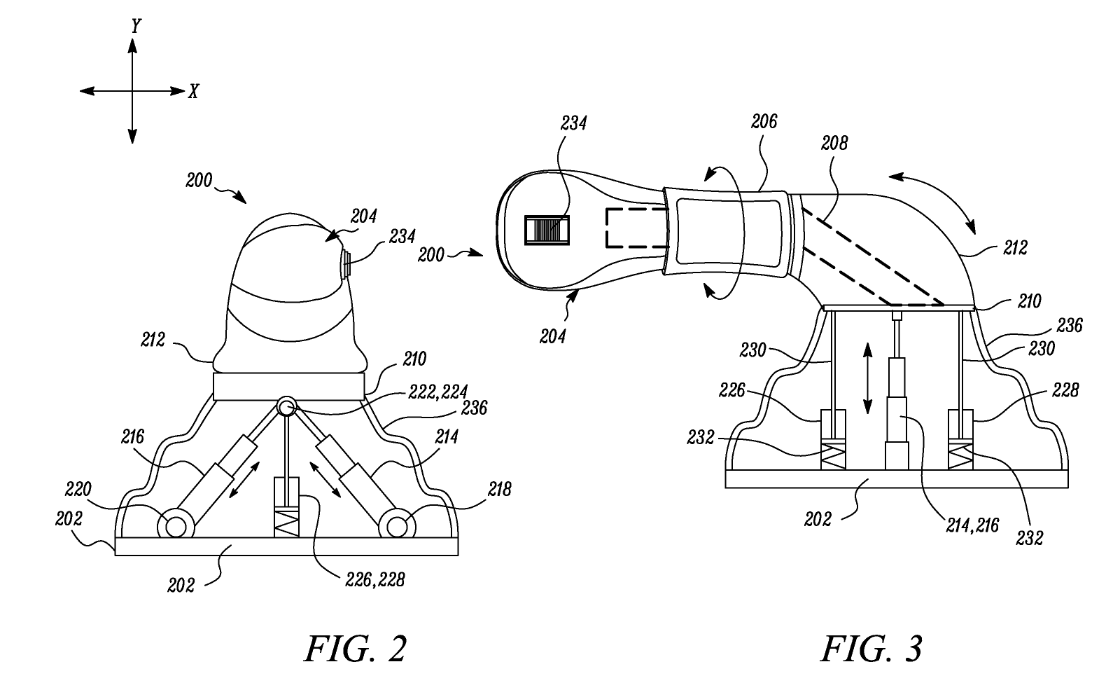

In an embodiment, the implement system 102 may be generally set in motion, to move the bucket 108, in a first vertical plane 110 defined by an X-axis and a Y-axis. The first vertical plane 110 is a plane lying parallel to the sagittal plane, i.e. plane dividing the right zone and the left zone of an operator. Further, while in use, the bucket 108 may be curled and uncurled relative to the stick 106 to dig, scoop up or empty the material. The implement system 102 may also be swingable by rotating the chassis 112 at a pivot base of the boom 104 about a vertical axis, for example along the Y-axis. An overall movement of the bucket 108 in the first vertical plane 110 may be achieved in three parts, first by raising and lowering the boom 104 with respect to the chassis 112, second by moving the stick 106 toward and outward with respect to the operator cab 120, and third by rotating the bucket 108 relative to the stick 106. The boom 104 may be raised and lowered by a pair of first hydraulic actuators 122, 124. The stick 106 may be moved toward and outward with respect to the operator cab 120 by a second hydraulic actuator 126. A third hydraulic actuator 128 may be used to curl and uncurl the bucket 108 relative to the stick 106. Moreover, the chassis 112, and the implement system 102 it carries, may be rotated about the Y-axis by a fourth hydraulic actuator 130, such as a hydraulic motor, with respect to the drive system 116. The operator cab 120 may house the control device 200 and other user interface devices for controlling the implement system 102 and the drive system 116. FIGS. 2 and 3 illustrate detailed views of the control device 200 in accordance with an embodiment of the present disclosure. FIG. 2 illustrates a side elevation view of an operation interface device (e.g., the control device 200), as seen from a left side of the machine 100 and FIG. 3 illustrates a front side view of the control device 200 as seen from a front side of the machine 100.

Referring to FIGS. 2 and 3, the control device 200 is embodied as a joystick and is provided on a right hand side of an operator seat. In an alternative embodiment, the control device 200 may be a joystick provided on a left hand side of the operator seat. The control device 200 is horizontally mounted on a base 202 such that an operator in the operator cab 120 can easily reach and grasp the control device 200 with his right hand. According to an embodiment of the present disclosure, the control device 200 may be lying in a plane parallel to the frontal plane of the operator. While the control device 200 is described as substantially horizontal, in other embodiments, the control device 200 may be tilted with respect to the horizontal plane.

Referring to FIG. 3, the control device 200 includes a handle portion 204. The handle portion 204 may include a rotatable sleeve 206 which is rotatable with respect to a central axis of the handle portion 204. The central axis of the handle portion 204 may be substantially horizontal or tilted with respect to the base 202 of the control device. The handle portion 204 may also act as a casing for a control rod 208 such that a seat 210 may be fixed to the control rod 208 at a proximal end 212 of the handle portion 204. According to an embodiment of the present disclosure, the control device 200 may include two linear actuators 214, 216 (see FIG. 2) connected between the base 202 and the seat 210. The linear actuators 214, 216 may form a kinematic chain including the linear actuators 214, 216 and the control rod 208. The kinematic chain may constrain the movement of the control rod 208, and thus constrain the movement of the handle portion 204 with respect to the base 202 by virtue of its connection with the linear actuators 214, 216. The linear actuators 214, 216 may be disposed in a second vertical plane, the second vertical plane defined by the X- axis and Y-axis and (hereinafter referred to as the X-Y plane) and connected by first revolute joints 218, 220, e.g., a pin joint or a hinge joint, at the base 202. The first revolute joints 218, 220 may allow a one-degree-of-freedom motion, such as, a uni-axial rotation of the linear actuators 214, 216 in the X-Y plane. Further, the linear actuators 214, 216 may be connected by second revolute joints 222, 224 at the seat 210. The second revolute joints 222, 224 may overlap with each other and also allow a uni-axial rotation of the linear actuators 214, 216 in the X-Y plane. The linear actuators 214, 216 may be telescopic piston cylinder devices including hydraulic or pneumatic cylinders and piston rods configured to retract or expand under the action of any external force. In various other alternative embodiments of the present disclosure, any of the linear actuators 214, 216 may be another type of linear actuator device, such as a linear slider, a rack and pinion mechanism, or any other kind of straight-line mechanism. In accordance with an embodiment of the present embodiment, the operator may reach for the control device 200 and, due to the linear actuators 214, 216 which may contract or expand, move the handle portion 204 along the X-axis and Y-axis (as shown by arrow heads in FIG. 2) to activate a scaled up movement of the implement system 102 in the in the first vertical plane 110.

As illustrated in FIG. 3, the control device 200 may further include two collapsible cylinders 226, 228, connected between the base 202 and the seat 210, to allow a left and right swing movement of the handle portion 204 (as shown by arrow heads in FIG. 3). The collapsible cylinders 226, 228 are disposed in a plane which is orthogonal relative to the X-Y plane. The collapsible cylinders 226, 228 may include respective rods 230 and springs 232. The rods 230 may be connected with the seat 210. In various other alternative embodiments, a pivotal joint or any other suitable arrangement may be used for achieving the swing movement of the handle portion 204 in the plane orthogonal relative to the X-Y plane. The collapsible cylinders 226, 228, which are generally biased towards a normal position, may collapse, under the action of an external force, to allow the handle portion 204 to swing left and right and activate a scaled up swing movement of the implement system 102 by rotating the chassis 112 about the Y-axis.

According to an embodiment of the present disclosure, the rotatable movement of the sleeve 206 may activate a scaled up curl and uncurl movement of the bucket 108 relative to the stick 106. Moreover, the control device 200 may include an input device 234 disposed at a distal end of the handle portion 204. The input device 234 may be embodied as a thumb-slider or thumbwheel, and may be turned to further adjust the scaled up curl and uncurl movement of the bucket 108 relative to the stick 106 while rotating the sleeve 206 on the handle portion 204. The control device 200 may include other types of input devices such as push buttons and switches without limiting scope of the present disclosure, these input devices may include electrical, magnetic, piezoelectric, optical, or electromechanical switches configured to output an electrical signal (either current or voltage signals). Further, a rubber bellows 236 for the control device 200 is provided for covering and sealing the linear actuators 214, 216 and the collapsible cylinders 226, 228.

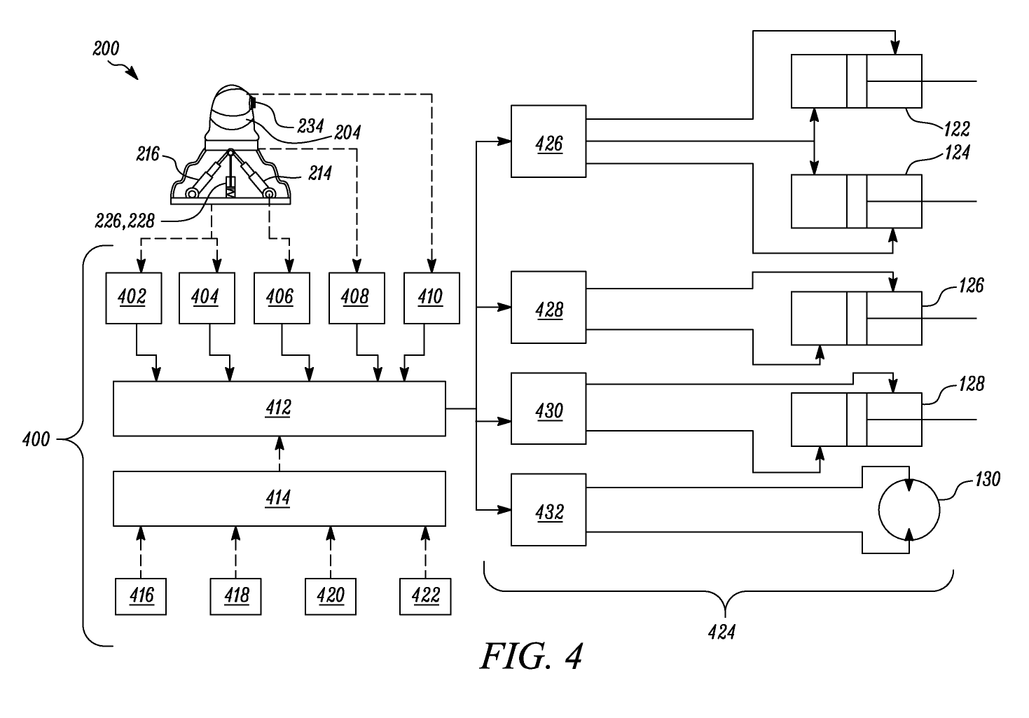

According to an embodiment of the present disclosure, the control device 200 may be used to control the movement of the linkages of the implement system 102 independently as well as in a simultaneously coordinated manner. The movement of the handle portion 204 with respect to the base 202 in the X-Y plane corresponds to the scaled up movement of the bucket 108 in the first vertical plane 110. Further, in order to keep the bucket 108 in a configuration for digging or loading operation, the operator may rotate the sleeve 206 on the handle portion 204 and also turn the input device 234 to curl or uncurl the bucket 108. Furthermore, in order to swing the implement system 102, the handle portion 204 may receive a swing movement either left or right. FIG. 4 is block diagram of a control system 400 for the machine 100.

The control system 400 is operatively connected with the control device 200 and a hydraulic control system 424 of the machine 100. The control system 400 may include a plurality of pilot valves 402 to 410, a hydraulic manifold 412, a controller 414, and a plurality of sensors 416 to 422. According to an embodiment, the hydraulic control system 424 may include a plurality of hydraulic control valves, such as a first hydraulic control valve 426, a second hydraulic control valve 428, a third hydraulic control valve 430, and a fourth hydraulic control valve 432 for controlling the first hydraulic actuators 122, 124, the second hydraulic actuator 126, the third hydraulic actuator 128, and the fourth hydraulic actuator 130 of the machine 100, respectively. The hydraulic control valves 426 to 432 may be direction control valves and which may be actuated by the pilot valves 402-404, 406-408 and 410, respectively. The pilot valves 402-404, 406-408 and 410 may be electromechanical, electric, magnetic control valves controlled by the movement of the linear actuators 214-216, the collapsible cylinders 216-218, rotation of the sleeve 206 and the input device 234, respectively. The pilot valves 402 to 410 are configured to supply a pressurized hydraulic fluid via the hydraulic manifold 412 to the hydraulic control valves 426 to 432 based on the movement of the handle portion 204. Consequently, the hydraulic actuators 122 to 130 may be driven to extend or retract depending upon the directional movement of the hydraulic control valves 426 to 432. Further, the amount of hydraulic pressure applied to the hydraulic actuators 122 to 130, and therefore the speed of movement of the hydraulic actuators 122 to 130, may be related to the degree to which the hydraulic control valves 426 to 432 are actuated.

The controller 414 is configured to control the operation of the hydraulic control system 424 to achieve the scaled up movement of the implement system 102 in response to at least one of the movement of the handle portion 204 with respect to the base 202, the rotation of the sleeve 206, and a turning of the input device 234. More specifically, the controller 414 is configured to control a supply of hydraulic fluid to the first, second, third and fourth hydraulic actuators 122-130 in response to at least one of the movement of the handle portion 204 with respect to the base 202, the rotation of the sleeve 206, and the turning of the input device 234. According to an embodiment of the present disclosure, the controller 414 is operatively connected with the plurality of sensors 416 to 422. These sensors 416 to 422 are configured to generate electrical signals indicative of the position and speed of the bucket 108, the boom 104, the stick 106, and the chassis 112. The sensors 416 to 422 may be GPS based sensors, magnetic sensors, angle encoders, inclinometers, or accelerometers associated with the linkages of the implement system 102 and/or the respective hydraulic actuators 122 to 130. The controller 414 may control the operation of the hydraulic manifold 412, to maintain and supply a target hydraulic fluid pressure to the hydraulic actuators 122 to 130 to achieve the scaled up movement of the implement system 102 in response to the movement of the handle portion 204. The controller 414 may include a processor and a memory component. The processor may include microprocessors or other processors as known in the art. In some embodiments the processor may include multiple processors. The processor may execute instructions for determining the fluid pressure for opening and closing of the hydraulic control valves 426 to 432 based on scaled up movement of the implement system 102.

According to an embodiment of the present disclosure, the controller 414 may further include lookup tables based on a transfer functions and/or position maps to calculate the position of the bucket 108 in the first vertical plane 110 corresponding to a position of the of the handle portion 204 in the X-Y plane. These lookup tables or position maps may be accessed to determine a scaled up target position of the bucket 108, which may be further compared with the output of the sensors 416 to 422 that may be indicative of an actual position of the bucket 108. Furthermore, the controller 414 is configured to process and calculate a differential between the target position and the actual position of the bucket 108 and accordingly provide feedback to the operator via the control device 200. The feedback may include tactile force feedback in case the movement of the handle portion 204 exceeds the corresponding target position of the bucket 108 to slowdown or even retard the movement of the handle portion 204. In an embodiment, the linear actuators 214, 216 may apply an adverse hydraulic pressure to resist the movement of the handle portion 204. Otherwise, the control device 200 may allow free movement of the handle portion 204 in the X-Y plane, while the differential between the target position and the actual position of the bucket 108 is negligibly small.

Moreover, the scaled up target position of the bucket 108 may be dependent on a pre-defined ratio, which can multiply the co-ordinates of the handle portion 204 with respect to the base 202 to determine the position of the bucket 108. The pre-defined ratio may be dependent on size and geometry of the implement system 102 and may be pre-programed in the controller 414. The controller 414 may include further a secondary storage device, a timer, and one or more processors that cooperate to accomplish a task consistent with the present disclosure. Numerous commercially available microprocessors may be configured to perform the functions of the controller 414. It should be appreciated that the controller 414 could readily embody a general machine controller capable of controlling numerous other functions of the machine 100. Various known circuits may be associated with the controller 414, including signal-conditioning circuitry, communication circuitry, and other appropriate circuitry. It should also be appreciated that the controller 414 may include one or more of an application-specific integrated circuit (ASIC), a field-programmable gate array (FPGA), a computer system, and a logic circuit configured to allow the controller 414 to function in accordance with the present disclosure.

### INDUSTRIAL APPLICABILITY

The disclosed control device 200 may be applicable to any excavation machine which involves planar and swinging movements of the implement system 102. The disclosed control device 200 may help to improve machine performance and efficiency by assisting the operator to use one control device for overall movement of the implement system 102.

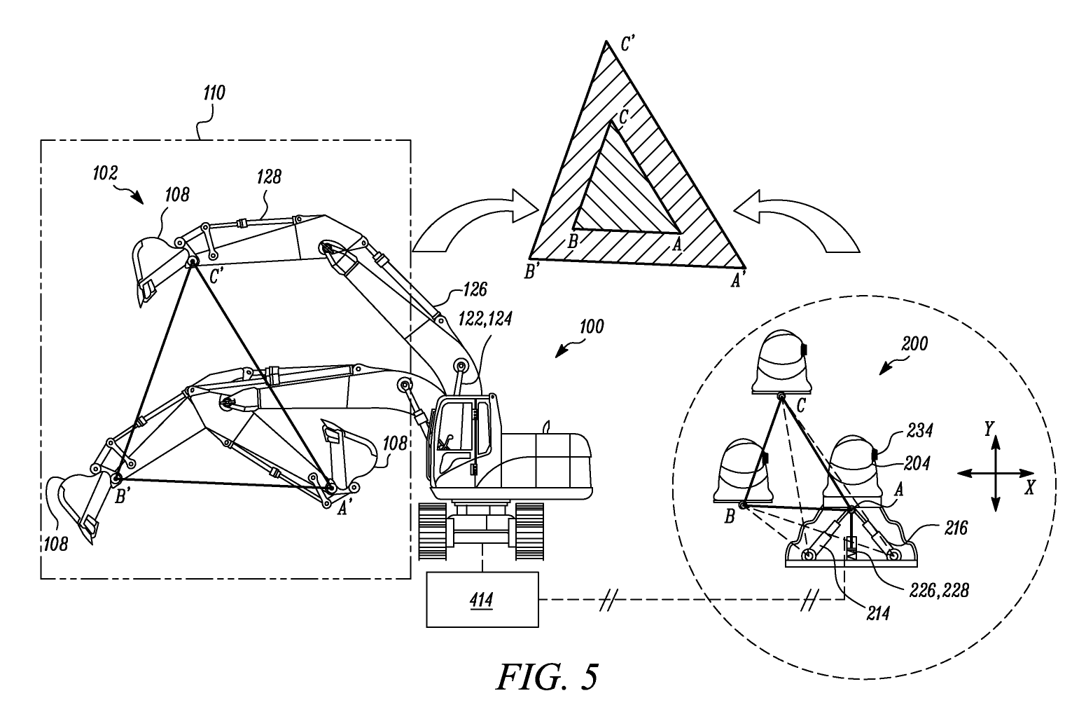

FIG. 5 is a diagrammatic view of the implement system 102 of the machine 100 and the control device 200 illustrating a movement interrelationship between two. As illustrated, the handle portion 204 is moveable relative to the base 202 in the X-Y plane by virtue of the retraction and expansion of the linear actuators 214, 216. A first position (A) of the handle portion 204 may correspond to a first position (A′) of the bucket 108 in the first vertical plane 110. The first position (A′) of the bucket 108 may be a parking station position for the bucket 108 when not in use or during transportation of the machine 100. The controller 414 is configured to control and supply the hydraulic fluid pressure in the hydraulic actuators 122-128 to maintain the first position (A′) of the bucket 108. As described above, the controller 414 may utilize lookup tables and position maps to map the first position (A) of the handle portion 204 with the first position (A′) of the bucket 108, until an external force is applied on the handle portion 204 to change its position in the X-Y plane.

While in use, in order to dig and scoop the material, the handle portion 204 is moved to a second position (B) in the X-Y plane with respect to the base 202. In this configuration, the linear actuators 214, 216 may extend and also tilt forward at the revolute joints 218-224 (as shown by dash lines). Thus, the bucket 108 is moved to the corresponding second position (B′). The controller 414 may initiate a coordinated and simultaneous expansion or retraction of the first and second hydraulic actuators 122-126 by supplying the hydraulic fluid. Further, the sleeve 206 on the handle portion 204 is rotated and the input device 234 may be turned to uncurl the bucket 108 to facilitate dig and scoop function, which may actuate the third hydraulic actuator 128. Moreover, the left and right swing of the handle portion 204 by virtue of collapsible cylinders 226, 228 may locate the bucket 108 at the desired location at a site by controlling the rotation of the fourth hydraulic actuator 130.

Further, the bucket 108 is moved to a third position (C′) to empty the material into a haul truck (not shown) or at a dumping site. To achieve this, the handle portion 204 is raised to a corresponding a third position (C) of the handle portion 204 by lifting up the handle portion 204 with respect to the base 202. Further, the bucket 108 can be uncurled to empty the material. As illustrated in FIG. 5, a first triangle ABC formed by handle portion 204, using the kinematic chain including the linear actuators and the control rod, and a second triangle A′B′C′ formed by the bucket 108 position in the first plane 110 are similar. Further, the second triangle A′B′C′ is scaled up shape of the first triangle ABC.

According to an aspect of the present disclosure, the operator is required to use a one hand only to achieve the overall movement of the implement system 102 in the first vertical plane 110, the curl and uncurl movement of the bucket 108 relative to the stick 106, and also the swing movement of the chassis 112 and the implement system 102 about the drive system 116. Moreover, based on the differential between the actual position and velocity of the bucket 108 and the position of the handle portion 204 in the X-Y plane the tactile force feedback is provided to the operator via the control device 200. This force feedback may promote the operator to either slowdown or even stop the movement of the handle portion 204.

It will be apparent to those skilled in the art that various modifications and variations can be made to the disclosed control device and hydraulic control system. Other embodiments will be apparent to those skilled in the art from consideration of the specification and practice of the disclosed control device and hydraulic control system. It is intended that the specification and examples be considered as exemplary only, with a true scope being indicated by the following claims and their equivalents.

We claim:

1. A control device for an implement system of a machine, the control device mounted on a base and comprising:
a handle portion having a rotatable sleeve;
a control rod encased in the handle portion;
a seat fixed to the control rod at a proximal end of the handle portion; and
two linear actuators connected between the base and the seat forming a kinematic chain including the linear actuators and the control rod.

2. The control device of claim 1, wherein the linear actuators are telescopic piston cylinder devices.

3. The control device of claim 1, wherein the linear actuators are disposed in a vertical plane and connected to the base by first revolute joints.

4. The control device of claim 3, wherein the linear actuators are connected to the seat by second revolute joints.

5. The control device of claim 1 further comprising two collapsible cylinders connected between the base and the seat.

6. The control device of claim 5, wherein the collapsible cylinders are disposed in an orthogonal plane relative to a vertical plane of the linear actuators.

7. The control device of claim 1 further comprising an input device disposed on the handle portion.

8. A machine comprising:
a drive system;
a chassis rotatably supported on the drive system;
an implement system connected with the chassis;
a hydraulic control system;
a control device for the implement system, the control device mounted on a base and including:
a handle portion having a rotatable sleeve;
a control rod encased in the handle portion;
a seat fixed to the control rod at a proximal end of the handle portion;
two linear actuators disposed in a vertical plane and connected between the base and the seat forming a kinematic chain including the linear actuators and the control rod;
two collapsible cylinders disposed in an orthogonal plane relative to the vertical plane of the linear actuators and connected between the base and the seat; and
an input device disposed on the handle portion; and
a controller configured to control the operation of the hydraulic control system to achieve a scaled up movement of the implement system in response to at least one of a movement of the handle portion with respect to the base and a turning of the input device.

9. The machine of claim 8, wherein the linear actuators of the control device are telescopic piston cylinder devices.

10. The machine of claim 8, wherein the linear actuators of the control device are connected to the base by first revolute joints.

11. The machine of claim 10, wherein the linear actuators of the control device are connected to the seat by second revolute joints.

12. The machine of claim 8, wherein the implement system includes a boom, a stick and a bucket.

13. The machine of claim 12, wherein the hydraulic control system includes a first hydraulic actuator associated with the boom, a second hydraulic actuator associated with the stick, a third hydraulic actuator associated with the bucket, and a fourth hydraulic actuator associated with the chassis.

14. The machine of claim 13, wherein the hydraulic control system includes a first hydraulic control valve associated with the first hydraulic actuator, a second hydraulic control valve associated with the second hydraulic actuator, a third hydraulic control valve associated with the third hydraulic actuator, and a fourth hydraulic control valve associated with the fourth hydraulic actuator.

15. The machine of claim 14, wherein the controller is configured to control a supply of hydraulic fluid to the first, second, third and fourth hydraulic actuators in response to the movement of the handle portion with respect to the base and the turning of the input device.

16. An excavator comprising:
a drive system;
a chassis rotatably supported on the drive system;
an implement system including:
a boom pivotally connected to the chassis;
a stick pivotally connected to the boom; and
a bucket pivotally connected to the stick;
a hydraulic control including:
a first hydraulic actuator associated with the boom;
a second hydraulic actuator associated with the stick;
a third hydraulic actuator associated with the bucket; and
a fourth hydraulic actuator associated with the chassis;
a control device for the implement system, the control device mounted on a base and including:
a handle portion having a rotatable sleeve;
a control rod encased in the handle portion;
a seat fixed to the control rod at a proximal end of the handle portion;
two linear actuators disposed in a vertical plane and connected between the base and the seat forming a kinematic chain including the linear actuators and the control rod;
two collapsible cylinders disposed in an orthogonal plane relative to the vertical plane of the linear actuators and connected between the base and the seat; and
an input device disposed on the handle portion; and
a controller configured to control a supply of hydraulic fluid to the first, second, third and fourth hydraulic actuators in response to at least one of a movement of the handle portion with respect to the base and a turning of the input device.

17. The excavator of claim 16, wherein the linear actuators of the control device are telescopic piston cylinder devices.

18. The excavator of claim 16, wherein the linear actuators of the control device are connected to the base by first revolute joints.

19. The excavator of claim 18, wherein the linear actuators of the control device are connected to the seat by second revolute joints.

20. The excavator of claim 16, wherein the hydraulic control system includes a first hydraulic control valve associated with the first hydraulic actuator, a second hydraulic control valve associated with the second hydraulic actuator, a third hydraulic control valve associated with the third hydraulic actuator, and a fourth hydraulic control valve associated with the fourth hydraulic actuator.
